(19) United States
(12) Patent Application Publication
(10) Pub. No.: US 2002/0104454 A1
(43) Pub. Date: Aug. 8, 2002

(54) Apparatus for cleaning a surface

(76) Inventor: Eric Verschueren, Merksplas (BE)

Correspondence Address: Joseph T. Guy Ph.D., Nexsen Pruet Jacobs & Pollard LLP, 201 W. McBee Avenue, Greenville, SC, 29603, US

(21) Appl. No.: 10/050,310

(22) Filed: Jan. 16, 2002

Related U.S. Application Data
(60) Provisional application No. 60/270,392, filed on Feb. 21, 2001.

(30) Foreign Application Priority Data
Feb. 6, 2001 (EP) 01000004.0

(51) Int. Cl. B41F 35/00; B41F 1/18

(52) U.S. Cl. 101/450.1; 101/425

(57) ABSTRACT

An apparatus for cleaning a surface is disclosed, the apparatus comprising

an elongated housing having at an end thereof an edge which surrounds an opening;

a jet or spray nozzle, which is disposed in the housing and spaced from the opening, for jetting or spraying a cleaning liquid on the surface through a portion of the opening, said portion having a perimeter;

a supply channel connected to the nozzle for supplying the cleaning liquid;

rubbing means for mechanically treating the surface, which are rotatably mounted and which extend from within the housing towards the opening and are disposed along said perimeter; said rubbing means and said housing defining a suction chamber;

an evacuation channel connected to the suction chamber for maintaining a sub-pressure in the suction chamber in order to remove the cleaning liquid drawn from between the rubbing means and any material released from the surface.

The apparatus is especially suited for removing ink-accepting areas from a lithographic printing master so as to recycle the lithographic substrate.

The application claims the benefit of U.S. Provisional application No. 60/270,392 filed on Feb. 21, 2001.

### FIELD OF THE INVENTION

The present invention relates to an apparatus for cleaning a surface, especially for removing the coating from a lithographic printing plate so that the lithographic substrate can be recycled and used again for applying a coating thereto.

### BACKGROUND OF THE INVENTION

Lithographic printing presses use a so-called printing master such as a printing plate which is mounted on a cylinder of the printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the so-called computer-to-film method wherein various pre-press steps such as typeface selection, scanning, color separation, screening, trapping, layout and imposition are accomplished digitally and each color selection is transferred to graphic arts film using an image-setter. After processing, the film can be used as a mask for the exposure of an imaging material called plate precursor and after plate processing, a printing plate is obtained which can be used as a master.

In recent years the so-called computer-to-plate method has gained a lot of interest. This method, also called direct-to-plate method, bypasses the creation of film because the digital document is transferred directly to a plate precursor by means of a so-called plate-setter. Especially thermal plates, which are sensitive to heat or infrared light are widely used in computer-to-plate methods, because of their daylight stability. Such thermal materials preferably comprise a compound that converts absorbed light into heat. The heat, which is generated on image-wise exposure, triggers a (physico-)chemical process, such as ablation, polymerization, insolubilization by cross-linking of a polymer, decomposition, or particle coagulation of a thermoplastic polymer latex, and after optional processing, a lithographic image is obtained.

Plates which do not require wet processing are particularly suited for on-press imaging in a so-called digital press, i.e. a printing press comprising an integrated exposure device on every color station. Such digital presses allow computer-to-press workflows wherein the unexposed plate precursor is first mounted on the print cylinder of each color station and the exposure is cared out while the plate is clamped on the cylinder, resulting in a good registration without the need of readjustment of the plate positions.

Whereas a plate precursor normally consists of a sheet-like support and one or more functional coatings, computer-to-press methods have been described, e.g. in GB1546532, wherein a composition, which is capable to form a lithographic surface upon image-wise exposure and optional processing, is provided directly on the surface of a plate cylinder of the press. EP-A 101 266 describes the coating of a hydrophobic layer directly on the hydrophilic surface of a plate cylinder. After removal of the non-printing areas by ablation, a master is obtained. Such on-press coating methods are also described in U.S. Pat. No. 5,713,287 and EP-A 802 457. After the press-run, the coating can be removed from the plate cylinder by an on-press cleaning step using a cleaning liquid and optionally mechanical rubbing, so that the cleaned substrate can be re-used in a next cycle of coating, exposure, printing and cleaning.

Devices for performing the cleaning step have been described in JP63-4947; U.S. Pat. No. 5,713,287; U.S. Pat. No. 5,644,986 and US 5,603,775. In the latter patent, a device is described as depicted in FIG. 1, which has been reproduced from U.S. Pat. No. 5,603,775. The nozzle head includes a housing 25 consisting of a casing with circular cross section, and a jet nozzle 24 arranged in the casing 25 in the immediate vicinity of the center line of the casing. The casing 25, which is preferably cylindrical, itself forms an elongate suction nozzle 26 which terminates in an orifice edge 29 surrounding an opening 39 free from mechanical parts. The suction nozzle 26 contains a chamber 32 comprising said opening 39 and is arranged spaced from the surface to be cleaned to form a circumferential gap 34 between the shell surface 22 and orifice edge 29. The jet nozzle 24 is arranged in the chamber 32 of the casing, spaced axially from the opening 39, to emit a jet 40 of cleaning liquid producing a predetermined treatment area 41 on the surface. A holder 27 carries the jet nozzle 24, the orifice 28 of which is located centrally in the casing 25. The front end of the suction nozzle 26 is shaped with a contour to fit the curvature of the surface to be cleaned to produce said gap 34. The holder 27 comprises a supply channel 30 communicating with the jet nozzle 24. The holder 27 is also provided with a plurality of peripheral, axial through-holes 31 through which an evacuation pipe communicates openly with the chamber 32 of the suction nozzle 26.

A problem associated with the on-press coating, exposure and cleaning methods is that the wet coating and cleaning steps involve a risk of damaging or contaminating the optics and electronics of the integrated image-setter. Often, the known cleaning methods also fail because no suitable compromise can be found between the chemical reactivity of the cleaning liquid versus the ink-accepting areas which have to be removed on the one hand and the required inertness of said cleaning liquid versus the fragile lithographic surface on the other hand. A typical lithographic surface is mechanically as well as chemically quite vulnerable. A lithographic surface consists generally of a micro-pore structure in order to obtain a good differentiation between the spreading properties of the ink and the fountain. Anodized aluminum plates comprise a lithographic surface containing one or more metal oxides on which absorption phenomena can take place. These metal oxides are very susceptible to chemical conversion into forms that are no longer lithographically active. The above mentioned micro-porosity of a lithographic surface is also highly susceptible to mechanical damage. The presence of solid particles in cleaning liquids, which is often required for efficient mechanical cleaning of the lithographic surface, results inevitably in a disturbance of the micro-structure of said surface. Because ink and the coated imaging layer penetrate in the micro-pore structure, it is necessary to carry out a vigorous cleaning so as to avoid ghost images in the subsequent printing cycles, which are due to an incomplete removal of the previous image.

### SUMMARY OF THE INVENTION

It is an object of the present invention to provide an apparatus for effectively cleaning a surface, in particular for removing the coating from a lithographic printing plate without damaging the lithographic quality of the substrate, and which reduces the risk of contaminating the environment, e.g. the optics and electronics of a nearby image-setter. It is also an object to provide a small apparatus which can easily be integrated in a printing press. These objects are realized by the apparatus defined in claim 1. The apparatus of claim 1 is essentially the same as the one depicted in FIG. 1, with the additional feature that, upon operation of the apparatus, rotating rubbing means 8 (FIG. 2 and 3), e.g. brush hairs, form a barrier between, on the one hand, the area of the surface 13 that is treated by the nozzle 4, i.e. the area which corresponds to the portion 5 of the opening 3, and, on the other hand, the suction chamber 9 so that the cleaning liquid and any material removed from the surface 13 first pass the rotating rubbing means before being drawn into the suction chamber.

Specific features for preferred embodiments of the invention are set out in the dependent claims. Further advantages and embodiments of the present invention will become apparent from the following description and drawings.

### BRIEF DESCRIPTION OF THE DRAWINGS

FIG. 1 is a perspective view of an apparatus known in the prior art.

FIG. 2 is a lateral view of a preferred embodiment of an apparatus according to the invention.

FIG. 3 is an end view of the apparatus shown in FIG. 2.

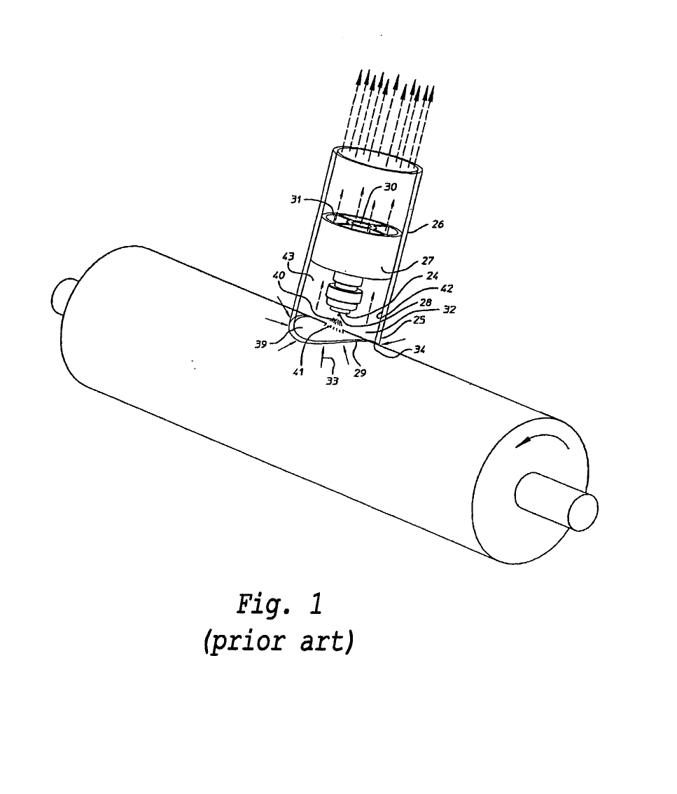

### DETAILED DESCRIPTION OF THE INVENTION

The apparatus of the present invention comprises an elongated housing 1, which is preferably cylindrical, having at an end thereof an edge 2 which surrounds an opening 3. The edge 2 preferably has a circular cross section and may be flat or concave, so as to comply with flat or curved surfaces to be cleaned. In a preferred embodiment, the edge 2 is inwardly curved and its curvature is the same as the curvature of the roll surface which is to be cleaned. The housing 1, edge 2 and opening 3 form a suction nozzle for removing the cleaning liquid and impurities from the surface 13. The term “impurities” refers to all material that, during operation of the apparatus, adheres to surface 13, in particular a lithographic coating on the surface of a lithographic substrate, together with ink, paper fibers, and any other material that is present on said coating and said surface.

The apparatus comprises one or more jet or spray nozzles 4, spaced from opening 3 by a certain distance, so that a cleaning liquid can be projected onto a treatment zone of surface 13. The terms “jet” and “spray” refer to a stream of a liquid phase, which is projected from nozzle 4 to surface 13. A “spray” is typically an aerosol of droplets of the cleaning liquid in pressurized air or another propellant. Preferred values of spray parameters have been defined in EP99203064, filed on Sep. 15, 1999. A “jet” is normally obtained without a propellant, preferably at a liquid supply pressure of between 50 and 150 bar and a supply rate of 20 to 60 ml/sec, more preferably 30 to 40 ml/sec.

The cleaning liquid is supplied to nozzle 4 via a supply channel 10, which is coupled to the known devices for feeding a liquid to a nozzle, such as a pump, hoses, filters, etc. In another embodiment, the apparatus also comprises a propellant supply channel (not shown in the figures) which forms a spray together with the cleaning liquid supplied via channel 10. The spray can be formed in nozzle 4 by the known methods, e.g. by passing a flow of propellant along the cleaning liquid as used in carburetors of combustion engines. Nozzle 4 may comprise a mixing chamber (now shown) wherein the propellant and the cleaning liquid are mixed.

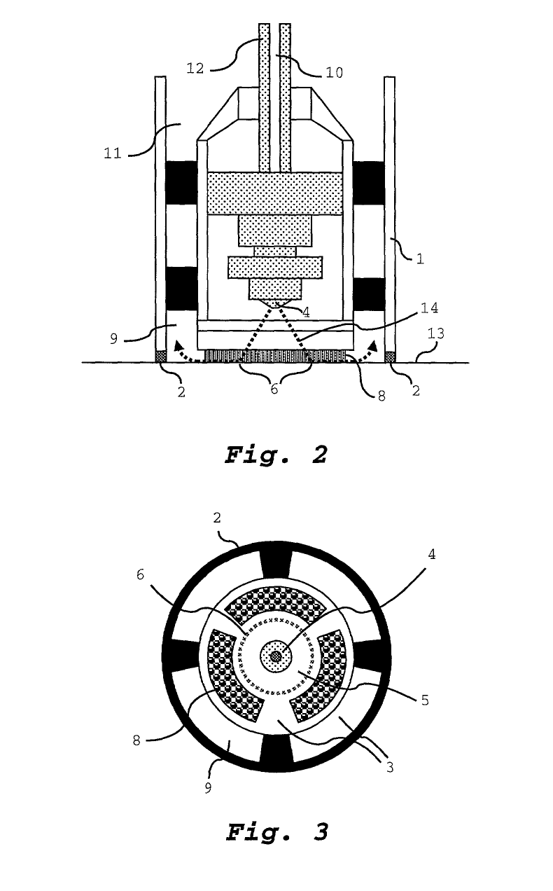

The jetted or sprayed liquid forms a body which may have any shape, that is referred to hereafter as a “cone”, regardless of the specific form of said body. The treatment zone of each nozzle 4 has an area which depends on the diverging angle of the jet or spray cone 14, the above mentioned distance between nozzle(s) 4 and surface 13 and the angle between the axis of cone 14 and surface 13. It should be stressed that the specific values of these angles and said distance depend on many parameters such as the nature of the impurities to be removed from surface 13, the composition of the cleaning liquid, and the composition and morphology of surface 13. Without limiting the scope of the invention thereto, typical values of the diverging angle of cone 14 may be between 5° and 50°, the distance between nozzle 4 and opening 3 is preferably between 60 and 100 mm, and the angle between the center axis of cone 14 and surface 13 may typically be between 45° and 90°. The latter angle is determined by the angle between the center axis of housing 1 and surface 13 as well as by the angle between the center axis of nozzle 4 and the center axis of housing 1. In a preferred embodiment, both the latter angles are about 90° as shown in FIG. 2. In a preferred embodiment, said diverging angle of cone 14, said distance between nozzle 4 and opening 3 and said angle between the center axis of nozzle 4 and the center axis of housing 1 is adjustable by the operator or by the manufacturer of the apparatus.

The distance between nozzle 4 and surface 13 is the sum of the distance between nozzle 4 and opening 3 on the one hand and the gap which is left during operation of the apparatus between opening 3 and surface 13 on the other hand. Preferably, said gap is essentially zero, i.e. during operation of the apparatus the edge 2 preferably touches surface 13 or is put very close to surface 13. Otherwise, a substantial gap may be left between the apparatus and surface 13, e.g. a few millimeters wide, so that air may flow from outside the apparatus into the suction chamber 9, thereby forming a barrier against liquid or impurities leaving the apparatus. Alternatively, air or another gas may be supplied to the gap from a distributor (not shown) around edge 2, as described in U.S. Pat. No. 5,603,775. If a gap is left between edge 2 and surface 13, then the rubbing means 8 should protrude beyond edge 2 so as to maintain mechanical contact between rubbing means 8 and surface 13.

In the embodiment wherein the apparatus comprises a single jet or spray nozzle 4, that nozzle is preferably positioned near the center axis of the housing 1. In another embodiment comprising a plurality of nozzles 4, these nozzles 4 may be positioned around the center axis of housing 1 and the axis of each nozzle 4 may be inclined versus the axis of housing 1 so that the treatment areas of all nozzles 4 overlap or are identical. According to still another embodiment, the treatment areas of each nozzle 4 do not overlap or overlap only to a minor extent so that the combined treatment area of all nozzles 4 is substantially larger that the treatment area of a single nozzle 4.

The jet or spray cone 14 of nozzle 4 intersects opening 3 to form portion 5 of said opening 3. Said portion 5 has a perimeter 6 which may have any form, but preferably is oblong, oval or circular (the latter is shown in FIG. 3). The treatment area has essentially the same shape as portion 5. The treatment area coincides with portion 5 when no gap is left between the apparatus and surface 13. In the embodiment wherein the treatment area has not a circular shape, nozzle 4 may be rotatably mounted in housing 1 so that a circular treatment area is produced by a single revolution along the center axis of nozzle 4.

The section of opening 3 which does not coincide with portion 5 forms a suction orifice that is coupled to a suction chamber 9, which is surrounded by housing 1. Said suction orifice preferably surrounds portion 5. Suction chamber 9 is coupled to an evacuation channel 11 which is coupled to means for maintaining a sub-pressure in suction chamber 9 at a level which produces the necessary suction force to evacuate effectively the cleaning liquid and impurities backwards from the suction orifice. Such means are generally known to the skilled person and may comprise a vacuum source such as a pump, hoses, filters, etc.

The rubbing means 8 in the apparatus of the present invention form a barrier between the jet or spray cone 14 and the suction chamber 9. More particularly, the rubbing means 8 extend from within the apparatus towards opening 3 and are positioned along perimeter 6 of the portion 5 of opening 3, wherein cleaning liquid is jetted or sprayed; the rubbing means thereby form a boundary between said portion 5 of opening 3 on the one hand and the suction chamber 9 on the other hand. The wording “along perimeter 6” shall be understood as meaning that the rubbing means 8 are positioned on or nearby perimeter 6. The rubbing means 8 may form a complete boundary or an incomplete boundary, i.e. the rubbing means 8 may be provided along the whole perimeter 6 or along a section or sections of perimeter 6 (3 sections shown in FIG. 3). The term “boundary” shall not be understood as a closed physical barrier for the cleaning liquid and impurities contained therein, since the advantageous effect of the present invention is produced by the effect that, upon operation of the apparatus, the jetted or sprayed cleaning liquid, which hits surface 13, passes through or between rubbing means 8 before being drawn into suction chamber 9 and evacuated. The rubbing means 8 can be e.g. composed of a fabric or cloth, which is permeable for the cleaning liquid, or of small rubbing bodies consisting of, covered with or coated with a material that is capable of effecting friction on surface 13, e.g. rubber, cotton, or plastic. In a preferred embodiment, rubbing means 8 comprise brush hairs between which the cleaning liquid can pass and enter into the suction chamber 9. An incomplete boundary, wherein the rubbing means 8 along perimeter 6 are spaced apart, may be advantageous for a better evacuation of cleaning liquid and impurities present therein.

The rubbing means 8 are rotatably mounted in the apparatus, e.g. on a shaft 12, so that the rubbing means 8 are capable of rotating, thereby exerting a friction on surface 13. The rotational movement of the rubbing means 8 can be driven by the known means, such as a motor. In a preferred embodiment, the rotation is driven by the pressure of the media that are supplied to nozzle 4, such as the cleaning liquid or propellant, e.g. by providing shaft 12 with one or more fins or other known means such as those used in drills driven by pressurized air.

The supply channel and the evacuation channel are preferably connected to a supply pipe and an evacuation pipe respectively, which may consist of a hose. The supply pipe for fresh cleaning liquid preferably extends inside the evacuation pipe for spent liquid and impurities. The supply pipe and/or the evacuation pipe may be connected to a service unit which preferably includes a tank for fresh cleaning liquid, equipment for treating the used liquid containing impurities, a vacuum pump connected to the evacuation pipe, an optional high-pressure pump connected to the supply pipe, filters, and the necessary electronics and mechanics for driving the service unit.

The apparatus of the present invention preferably cleans surface 13 scanwise. When used for cleaning a cylindrical surface such as a print cylinder of a printing press, the apparatus is preferably guided along a line parallel to the axis of the cylinder while the cylinder itself rotates and the edge of the apparatus is held at a constant distance close to the surface. The center axis of the housing 1 is preferably held perpendicular to the surface, although other configurations are also possible. During the cleaning operation, the axial translation of the apparatus and the revolution speed of the cylinder are preferably driven by a control unit which may also be coupled to the service unit that controls the rate of feed to the nozzle head and the rate of evacuation from the suction chamber. Both supply and evacuation pressures are preferably addusted so as to obtain efficient cleaning without any liquid or impurities penetrating out the apparatus through the gap, and preferably also to obtain an essentially dry surface immediately after the passage of the apparatus.

According to a first method of the present invention, the cleaning of surface 13 is carried out by jetting or spraying a cleaning liquid with an apparatus as defined above and evacuating the cleaning liquid together with the impurities via the suction chamber. The cleaning may be achieved by chemical as well as mechanical effects. Suitable cleaning liquids comprise solvents wherein the impurities are dispersed or solubilized. The impact of droplets of the cleaning liquid may further produce a mechanical impact on surface 13, which may be enhanced by the addition of solid particles in the cleaning liquid, by ultrasonic treatment, etc. However, the presence of rubbing means 8 in the apparatus of the present invention also enables an effective cleaning without substantially pressurizing the cleaning liquid or the propellant. It is normally sufficient to supply the cleaning liquid at about atmospheric pressure to surface 13, since the action of rubbing means 8 effects the mechanical cleaning thereof.

In another method according to the present invention, a film of a first cleaning liquid is applied on surface 13, e.g. by using the apparatus of the present invention as a coating apparatus, i.e. without engaging the vacuum suction. After a suitable period of time, during which the cleaning liquid attacks the impurities, the apparatus is used for spraying or jetting a second cleaning liquid onto the surface and removing impurities from the surface by engaging the vacuum suction. The second cleaning liquid can be the same as the first cleaning liquid. Preferably, the second cleaning liquid does not chemically attack the impurities but is only used as a carrier for withdrawing the impurities from the surface, e.g. plain water.

According to still another method of the present invention, a film of a cleaning liquid is applied on surface 13 as described above and, after a while, said film is removed together with impurities by engaging only the vacuum suction of the apparatus, i.e. without supplying a second cleaning liquid.

As mentioned above, the apparatus of the present invention is particularly suited for removing ink-accepting areas from a lithographic surface, also called herein lithographic substrate, so as to recycle said substrate which then can be provided with a fresh image-recording layer. The cleaning step can be performed on-press, i.e. while the printing master is mounted in a printing press, or off-press, e.g. in a dedicated cleaning device which comprises an apparatus according to the present invention. Such a cleaning device can be mechanically coupled to the printing press, i.e. the printing master can be automatically removed from the press and conveyed to the cleaning device by mechanical means so that the printing master(s) can be exchanged without human intervention. According to a preferred embodiment, the apparatus of the present invention is present in a digital press, which also comprises an integrated plate-setter. According to a most preferred embodiment, the printing press also comprises an on-press coating unit which applies a lithographic coating on the substrate, which may be a plate mounted around the plate cylinder of the press or the plate cylinder itself. After coating, an integrated plate-setter exposes the coating image-wise to heat or light, and after optional processing, the printing press is started. After the press-run, the ink-accepting areas are removed with an apparatus according to the present invention, and the recycled substrated can then be reused in a next cycle of coating, exposure, printing and cleaning. All these steps are preferably performed on-press, i.e. while the lithographic substrate is mounted in a printing press.

The lithographic substrate used in the methods of the present invention may be a sheet-like material such as a plate or it may be a cylindrical element such as a sleeve which can be slid around a print cylinder of a printing press. Alternatively, the substrate can also be the print cylinder itself. In the latter option, the image-recording layer is provided on the print cylinder, e.g. by on-press spraying or jetting of a coating liquid. The lithographic substrate may be a hydrophilic support or a support which is provided with a hydrophilic layer. Preferably, the support is a metal support such as aluminum or stainless steel.

A particularly preferred lithographic substrate is an electrochemically grained and anodized aluminum support. The anodized aluminum support may be treated to improve the hydrophilic properties of its surface. For example, the aluminum support may be silicated by treating its surface with a sodium silicate solution at elevated temperature, e.g. 95° C. Alternatively, a phosphate treatment may be applied which involves treating the aluminum oxide s surface with a phosphate solution that may further contain an inorganic fluoride. Further, the aluminum oxide surface may be rinsed with a citric acid or citrate solution. This treatment may be carried out at room temperature or may be carried out at a slightly elevated temperature of about 30 to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulfonic acid, polyvinylbenzenesulfonic acid, sulfuric acid esters of polyvinyl alcohol, and acetals of polyvinyl alcohols formed by reaction with a sulfonated aliphatic aldehyde It is further evident that one or more of these post treatments may be carried out alone or in combination. More detailed descriptions of these treatments are given in GB-A-1 084 070, DE-A-4 423 140, DE-A-4 417 907, EP-A-659 909, EP-A-537 633, DE-A-4 001 466, EP-A-292 801, EP-A-291 760 and U.S. Pat. No. 4,458,005.

According to another embodiment, the substrate can also be a flexible support, which is provided with a hydrophilic layer, hereinafter called ‘base layer’. The flexible support is e.g. paper, plastic film or aluminum. Preferred examples of plastic film are polyethylene terephthalate film, polyethylene naphthalate film, cellulose acetate film, polystyrene film, polycarbonate film, etc. The plastic film support may be opaque or transparent.

The base layer is preferably a cross-linked hydrophilic layer obtained from a hydrophilic binder cross-linked with a hardening agent such as formaldehyde, glyoxal, polyisocyanate or a hydrolyzed tetra-alkylorthosilicate as disclosed in EP-A-601 240, GB-P-1 419 512, FR-P-2 300 354, U.S. Pat. No. 3,971,660, and U.S. Pat. No. 4,284,705. It is particularly preferred to use a film support to which an adhesion improving layer, also called subbing layer, has been provided. Particularly suitable adhesion improving layers for use in accordance with the present invention comprise a hydrophilic binder and colloidal silica as disclosed in EP-A-619 524, EP-A-620 502 and EP-A-619 525. Preferably, the amount of silica in the adhesion improving layer is between 200 mg/M² and 750 mg/M². Further, the ratio of silica to hydrophilic binder is preferably more than 1 and the surface area of the colloidal silica is preferably at least 300 m²/gram, more preferably at least 500 m²/gram.

The imaging material used in the methods of the present invention comprises at least one image-recording layer provided on the lithographic substrate. Preferably, only a single layer is provided on the substrate. The material may be light- or heat-sensitive, the latter being preferred because of daylight-stability. The image-recording layer of the material is preferably non-ablative. The term “non-ablative” shall be understood as meaning that the image-recording layer is not substantially removed during the exposure step. The imaging material is preferably processless, i.e. a lithographic image is obtained immediately after exposure without wet processing, or it can be processed by the supply of dampening liquid and/or ink, i.e. simply by starting the pressrun.

The material can be positive-working, i.e. the exposed areas of the image-recording layer are rendered removable with a processing liquid, thereby revealing the hydrophilic surface of the lithographic substrate which defines the non-printing areas of the master, whereas the non-exposed areas are not removable with a processing liquid such as fountain and define the hydrophobic, printing areas of the master. In a more preferred embodiment, the material is negative-working, i.e. the unexposed areas of the image-recording layer are removable with the processing liquid, thereby revealing the hydrophilic surface of the lithographic substrate which defines the non-printing areas of the master, whereas the exposed areas are not removable with the processing liquid and define the hydrophobic, printing areas of the master. The term “removable” indicates that the image-recording layer can be removed from the lithographic substrate by the supply of processing liquid, e.g. by dissolution of the layer in the liquid or by the formation of a dispersion or emulsion of the layer in the liquid.

Two highly preferred embodiments of a highly preferred negative-working image-recording layer will now be discussed.

In a first highly preferred embodiment, the working mechanism of the imaging layer relies on the heat-induced coalescence of hydrophobic thermoplastic polymer particles, preferably dispersed in a hydrophilic binder, as described in e.g. EP 770 494; EP 770 495; EP 770 497; EP 773 112; EP 774 364; and EP 849 090. The coalesced polymer particles define a hydrophobic, printing area which is not readily removable with dampening liquid and/or ink whereas the unexposed layer defines a non-printing area which is readily removable with dampening liquid and/or ink. The thermal coalescence can be induced by direct exposure to heat, e.g. by means of a thermal head, or by the light absorption of one or more compounds that are capable of converting light, more preferably infrared light, e.g. emitted by a solid state laser, into heat. Particularly useful light-to-heat converting compounds are for example dyes, pigments, carbon black, metal carbides, borides, nitrides, carbonitrides, bronze-structured oxides, and conductive polymer dispersions such as polypyrrole, polyaniline or polythiophene-based conductive polymer dispersions. Infrared dyes and carbon black are highly preferred.

The hydrophobic thermoplastic polymer particles preferably have a coagulation temperature above 35° C. and more preferably above 50° C. Coagulation may result from softening or melting of the thermoplastic polymer particles under the influence of heat. There is no specific upper limit to the coagulation temperature of the thermoplastic hydrophobic polymer particles, however the temperature should be sufficiently below the decomposition of the polymer particles. Preferably the coagulation temperature is at least 10° C. below the temperature at which the decomposition of the polymer particles occurs. Specific examples of hydrophobic polymer particles are e.g. polyethylene, polyvinyl chloride, polymethyl (meth)acrylate, polyethyl (meth)acrylate, polyvinylidene chloride, polyacrylonitrile, polyvinyl carbazole, polystyrene or copolymers thereof. Most preferably used is polystyrene. The weight average molecular weight of the polymers may range from 5,000 to 1,000,000 g/mol. The hydrophobic particles may have a particle size from 0.01 μm to 50 μm, more preferably between 0.05 μm and 10 μm and most preferably between 0.05 μm and 2 μm. The amount of hydrophobic thermoplastic polymer particles contained in the image forming layer is preferably between 20% by weight and 65% by weight and more preferably between 25% by weight and 55% by weight and most preferably between 30% by weight and 45% by weight.

Suitable hydrophilic binders are for example synthetic homo- or copolymers such as a polyvinylalcohol, a poly(meth)acrylic acid, a poly(meth)acrylamide, a polyhydroxyethyl(meth)acrylate, a polyvinylmethylether or natural binders such as gelatin, a polysacharide such as e.g. dextran, pullulan, cellulose, arabic gum, alginic acid.

In the second highly preferred embodiment, the imaging layer comprises an aryldiazosulfonate homo- or copolymer which is hydrophilic and removable in dampening liquid and/or ink before exposure and rendered hydrophobic and less removable after such exposure. The exposure can be done by the same means as discussed above in connection with thermal coalescence of polymer particles. Alternatively, the aryldiazosulfonate polymer can also be switched by exposure to UV light, e.g. by a UV laser or a UV lamp.

Preferred examples of such aryldiazosulfonate polymers are the compounds which can be prepared by homo- or copolymerization of aryldiazosulfonate monomers with other aryldiazosulfonate monomers and/or with vinyl monomers such as (meth)acrylic acid or esters thereof, (meth)acrylamide, acrylonitrile, vinylacetate, vinylchloride, vinylidene chloride, styrene, α-methyl styrene etc. Suitable aryldiazosulfonate polymers for use in the present invention have the following formula:

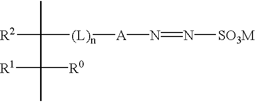

wherein R^{0,1,2} each independently represent hydrogen, an alkyl group, a nitrile or a halogen, e.g. Cl, L represents a divalent linking group, n represents 0 or 1, A represents an aryl group and M represents a cation. L preferably represents divalent linking group selected from the group consisting of —XT—CONR³—, —Xₜ—COO—, —X— and —Xₜ—CO—, wherein t represents 0 or 1, R³ represents hydrogen, an alkyl group or an aryl group, X represents an alkylene group, an arylene group, an alkylenoxy group, an arylenoxy group, an alkylenethio group, an arylenethio group, an alkylenamino group, an arylenamino group, oxygen, sulfur or an aminogroup. A preferably represents an unsubstituted aryl group, e.g. an unsubstituted phenyl group or an aryl group, e.g. phenyl, substituted with one or more alkyl group, aryl group, alkoxy group, aryloxy group or amino group. M preferably represents a cation such as NH₄⁺ or a metal ion such as a cation of Al, Cu, Zn, an alkaline earth metal or alkali metal.

Suitable aryldiazosulfonate monomers for preparing the above polymers are disclosed in EP-A 339393, EP-A 507008 and EP-A 771645.

The imaging material may also comprise other layers provided on the lithographic substrate, in addition to the image-recording layer. The light absorbing compound may be present in another layer close to the layer which contains the other ingredients mentioned above, such as the hydrophobic thermoplastic polymer particles and the aryldiazosulfonate polymer. Or the imaging material may comprise a protective top layer which is removable by the processing liquid, dampening liquid and/or ink and which provides protection against handling or mechanical damage. A suitable protective top layer comprises polyvinylalcohol.

Suitable cleaning liquids and cleaning methods, which are particularly effective for treating the above imaging materials have been described in the following EP-A's : EP00200176 (filing date 18.01.2000), EP00200177 (id.), EP00200178 (id.), EP00203224 (18.09.2000), EP00204090 (21.11.2000), EP00204093 (id.) and EP00204376 (07.12.2000). Suitable off-press cleaning methods and equipment therefor have been described in EP00203967 and EP00203968 (both filed on 14.11.2000).

We claim:

1. An apparatus for cleaning a surface, the apparatus comprising
an elongated housing having at an end thereof an edge which surrounds an opening;
a jet or spray nozzle, which is disposed in the housing and spaced from the opening, for jetting or spraying a cleaning liquid on the surface through a portion of the opening, said portion having a perimeter;
a supply channel connected to the nozzle for supplying the cleaning liquid;
rubbing means for mechanically treating the surface, which are rotatably mounted and which extend from within the housing towards the opening and are disposed along said perimeter; said rubbing means and said housing defining a suction chamber;
an evacuation channel connected to the suction chamber for maintaining a sub-pressure in the suction chamber in order to remove the cleaning liquid drawn from between the rubbing means and any material released from the surface.

2. An apparatus according to claim 1 wherein the rubbing means are brush hairs.

3. An apparatus according to claim 1 or 2 further comprising a second supply channel connected to the nozzle for supplying a propellant.

4. An apparatus according to claim 3 further comprising means for driving rotation of the rubbing means by the propellant.

5. An apparatus according to claim 1 or 2 wherein the rubbing means are provided along one or more sections of the perimeter, but not along the complete perimeter.

6. A printing method comprising
(i) applying an image-recording layer on a lithographic surface;
(ii) exposing the layer image-wise to heat or light, and optionally processing the exposed layer;
(iii) printing;
(iv) removing ink-accepting areas from the surface by means of an apparatus comprising
an elongated housing having at an end thereof an edge which surrounds an opening;
a jet or spray nozzle, which is disposed in the housing and spaced from the opening, for jetting or spraying a cleaning liquid on the surface through a portion of the opening, said portion having a perimeter;
a supply channel connected to the nozzle for supplying the cleaning liquid;
rubbing means for mechanically treating the surface, which are rotatably mounted and which extend from within the housing towards the opening and are disposed along said perimeter; said rubbing means and said housing defining a suction chamber;
an evacuation channel connected to the suction chamber for maintaining a sub-pressure in the suction chamber in order to remove the cleaning liquid drawn from between the rubbing means and any material released from the surface.

7. An apparatus according to claim 6 wherein the rubbing means are brush hairs.

8. An apparatus according to claim 6 or 7 further comprising a second supply channel connected to the nozzle for supplying a propellant.

9. An apparatus according to claim 8 further comprising means for driving rotation of the rubbing means by the propellant.

10. An apparatus according to claim 6 or 7 wherein the rubbing means are provided along one or more sections of the perimeter, but not along the complete perimeter.

11. A method according to claim 6 or 7 wherein all the steps are performed on-press.

12. A method according to claim 11 wherein the image-recording layer comprises hydrophobic thermoplastic polymer particles.

13. A method according to claim 11 wherein the image-recording layer comprises an aryldiazosulfonate polymer.
